(19) United States
(12) Patent Application Publication
(10) Pub. No.: US 2026/0269588 A1
(43) Pub. Date: Sep. 10, 2026

(54) IMPROVED UMBILICAL TERMINATION MODULE

(71) Applicant: TechnipFMC Norge AS, Kongsberg (NO)

(72) Inventor: Ragnar Eretveit, Kongsberg (NO)

(21) Appl. No.: 19/471,960

(22) PCT Filed: Apr. 2, 2024
(86) PCT No.: PCT/EP2024/058927

§ 371 Date: Oct. 2, 2025

(30) Foreign Application Priority Data
Apr. 4, 2023 (NO) 20230381

(51) Int. Cl. H02G 3/16; H02G 1/10; H02J 3/38; H02J 101/20

(52) U.S. Cl. CPC H02G 3/16; H02G 1/10; H02J 3/381; H02J 2101/20

(57) ABSTRACT

A retrievable umbilical termination module (UTM) is provided for a power distribution system. The UTM includes a first wet-mate connector directly connectable to a subsea transformer module, and a second connector connectable to one or more offshore power-generating apparatus. The first and second connectors are electrically connected to one another. The UTM further comprises an integrated switchgear or disconnection switch that is adapted to selectively control the flow of power from the second connector to the first connector. A subsea power system comprising the UTM, as well as methods for installing and retrieving the UTM, are also provided.

### FIELD OF THE DISCLOSURE

The present disclosure relates generally to the field of power distribution systems, and in particular to subsea power distribution systems. More specifically, the present disclosure describes an improved umbilical termination assembly or module having an integrated switchgear.

### BACKGROUND

An umbilical termination assembly (UTA) is a component structured to terminate umbilical cables and provide one or more connections for hydraulic, chemical, electrical, or fibre optic services. A particular use of UTAs is in subsea power distribution systems, which receive power from offshore energy-generating devices and distribute the power to various onshore apparatuses. In practice, an umbilical cable is installed such that it runs along a seabed and carries power from a wind turbine to a UTA at a remote end of the cable. Upon reaching the UTA, the umbilical cable is terminated into a plurality of wires, and electricity is distributed to a subsea transformer. Such power systems often comprise subsea switchgear modules that are used to de-energize equipment in order to allow safe maintenance, installation, or retrieval of previously powered apparatuses.

Known subsea power distribution systems have a subsea switchgear module, which includes multiple circuit breakers, remote and separate from the UTA, and this presents numerous disadvantages. Since the connections between the switchgear module and UTA are made underwater, “wet-mate” connectors are used to electrically couple the components. However, such connectors are significantly more expensive than connecting components above the surface using “dry-mate” connectors. Furthermore, providing a switchgear module as a separate and remote component to the UTA results in increased hardware cost, a larger system size, and leads to the input wet-mate connector system being operable close to its maximum power rating, which thereby reduces its lifetime.

Aspects of the present disclosure seek to provide an alternative arrangement of subsea components that alleviate these problems with prior known systems. In particular, aspects of the present disclosure seek to provide an improved umbilical termination module (UTM) that integrates the functionality of a switchgear module, leading to a more efficient and cost-effective power distribution system.

### SUMMARY

Embodiments of the present disclosure provide a retrievable umbilical termination module (UTM). The UTM comprises a first wet-mate connector directly connectable to a subsea transformer module and a second connector connectable to one or more offshore power-generating apparatuses. The first connector and the second connector are electrically connected to one another. The UTM further comprises a switchgear, the switchgear being adapted to selectively control the flow of power from the second connector to the first connector.

The switchgear may be a circuit breaker. Alternatively, the switchgear may be a disconnecting switch, wherein the system further comprises an actuator electrically coupled to the disconnecting switch, the actuator configured to activate or deactivate the disconnecting switch.

The second connector of the UTM may be a dry-mate connector. Alternatively, the UTM may comprise a first module containing the first connector and the switchgear element; and a second module connectable to the one or more offshore power-generating apparatuses; wherein the second connector is a wet-mate connector between the switchgear and the second module.

Embodiments of the present disclosure provide a subsea power system comprising a transformer module having a first side connectable to onshore components; and at least one UTM. The first wet-mate connector is connected to a second side of the transformer module.

In embodiments, one or more offshore power-generating apparatuses are connected to the second connector. The at least one offshore power-generating apparatuses may include a plurality of arrays of offshore power-generating apparatuses, such that the system comprises a respective UTM for each of the plurality of arrays.

Embodiments of the present disclosure provide a method for installing an umbilical termination module (UTM). The method comprises connecting the second connector to one or more offshore power-generating apparatus prior to subsea installation; installing the UTM subsea; and connecting the first wet-mate connector to the second side of a subsea transformer module.

Optionally, the UTM further comprises a first module containing the first connector and the switchgear, and a second module connected to the one or more offshore power-generating apparatuses, wherein the second connector is a wet-mate connector between the switchgear and the second module. In this arrangement, the method comprises the steps of disconnecting the first module from the second module; retrieving the first module to a surface vessel or platform; and disconnecting the second connector between the UTM and the one or more offshore power-generating apparatus.

### BRIEF DESCRIPTION OF THE DRAWINGS

The disclosure will be further described with reference to examples depicted in the accompanying figures, in which:

FIG. 1 is a schematic diagram of a subsea power distribution system;

FIG. 2 is a schematic diagram of an umbilical termination module employed in the system of FIG. 1; and

FIG. 3 is a schematic diagram of an alternative umbilical termination module.

### DETAILED DESCRIPTION

The following description presents particular examples and, together with the drawings, serves to explain principles of the disclosure. However, the scope of the embodiments is not intended to be limited to the precise details of the examples, since variations will be apparent to a skilled person and are deemed to be covered by the description. Terms for components used herein should be given a broad interpretation that also encompasses equivalent functions and features. In some cases, alternative terms for structural features may be provided, but such terms are not intended to be exhaustive.

Embodiments of the present disclosure provide an umbilical termination module (UTM) 30 having an integrated switchgear to provide a less expensive and more efficient power distribution system than those employing conventional umbilical termination assemblies.

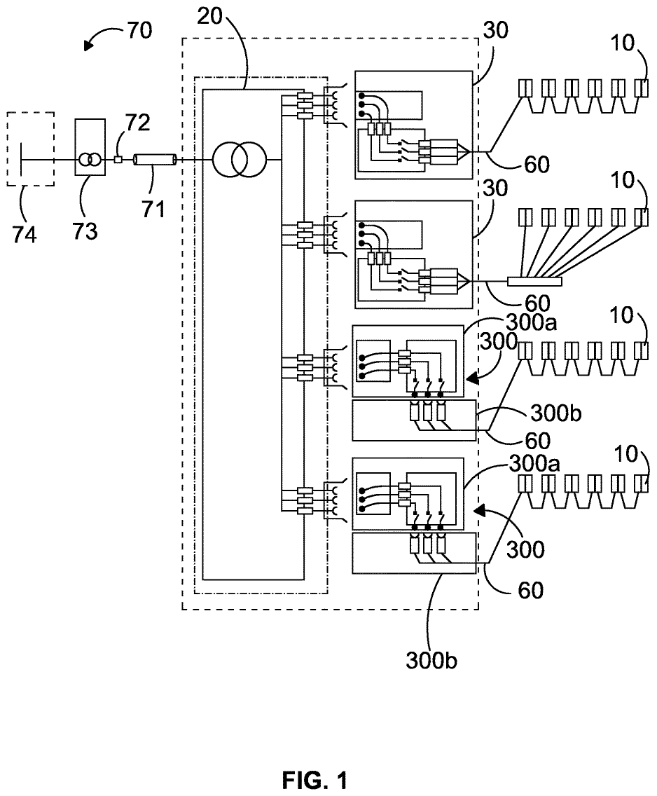

FIG. 1 is a schematic diagram of a subsea power distribution system having a plurality of UTMs 30. As depicted, the power distribution system is connectable to at least one array of offshore power generating apparatus 10 structured to generate high-voltage power. Each array has one or more offshore power-generating apparatuses 10, which is electrically connected with a corresponding UTM 30 via an umbilical cable 60. For avoidance of doubt, an “array” may comprise a single power-generating apparatus 10. Alternatively, the array may comprise multiple power-generating apparatuses 10 connected in series or parallel. Examples of the offshore power-generating apparatus 10 include, but are not limited to, wind turbines, offshore solar panels, and tidal energy devices.

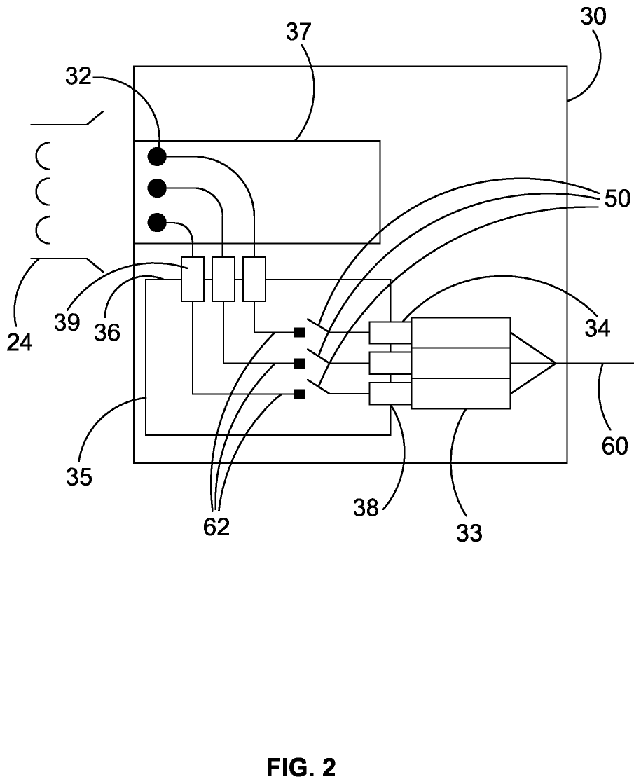

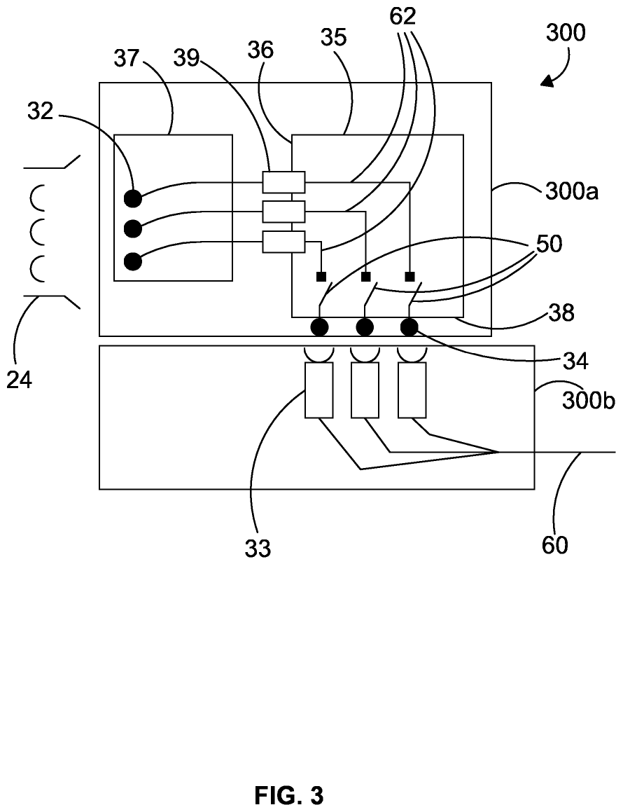

As best seen in FIGS. 2 and 3, each UTM 30 is provided with a first connector 32 and a second connector 34, which are electrically coupled to one another. The second connector 34 is connectable to the one or more offshore power-generating apparatus 10. The first connector 32 is a wet-mate connector directly connectable to a first side 24 of a subsea transformer module 20. The transformer module 20 comprises a step-down transformer structured to decrease the relatively high incoming voltage from the UTM by conventional means easily understood by a person skilled in the art. A second side of the transformer module 20 is connectable to various onshore components 70, such as an export cable 71, a high voltage junction box (HVJB) 72, an onshore transformer 73, and onshore switchgear 74.

FIG. 2 is a first example of the UTM 30. The UTM 30 comprises a housing 35 defining an enclosure, and an apparatus 37. The enclosure can be gas or oil-filled. The apparatus 37 is structured to provide a wet-mate connection between the UTM 30, and the subsea transformer module 20. A first side 36 of the housing 35 is provided with a dry-mate connector 39 coupling the housing 35 to the apparatus 37. Connecting wires 62 proximate to a second side 38 of the housing 35 are dry-mated to a termination head 33 via second connector 34.

As depicted, the termination head 33 is structured to terminate the umbilical cable 60, and separate the various cables bundled into the umbilical cable 60 into a plurality of terminals which are connected to the second connector 34. A switchgear 50 located in the housing 35 has three switches in parallel, where each switch has a connecting wire 62 which connects the second connector 34 to the dry-mate connector 39. The switchgear 50 is configured to selectively control the flow of power from the second connector 34 to the first connector 32 via the dry-mate connector 39. The switchgear 50 is thereby movable between an “open” position, wherein current is unable to flow across the UTM 30; and a “closed” position, wherein current can flow across the UTM 30. The switchgear 50 further comprises an actuator (not shown) structured to move the switchgear between “open” and “closed” positions. The actuator may be operated manually, automatically, or both.

As would be understood by a person skilled in the art, “switchgear” is a broad term that describes a variety of switching devices suitable for controlling, protecting, regulating, and isolating power systems. In some embodiments, the switchgear 50 is a circuit breaker designed to prevent the flow of electricity across the UTM 30 upon detection of a fault in the circuit. A fault would be understood by those skilled in the art as when the conditions in the UTM 30 stray adversely from safe operating parameters. Thus, the fault may be when the flow of current through the UTM 30 exceeds a predetermined rating proximate and above the typical operating current of the UTM 30. Further examples of faults in the UTM 30 include short-circuiting or overheating. The circuit breaker may be a conventional design of a switch connected to either a bimetallic strip or an electromagnet. In some embodiments, the switchgear 50 is a disconnecting switch. As understood by those skilled in the art, the disconnection switch can only be operated without voltage in the system.

FIG. 3 is an alternative example of a UTM 300. What distinguishes this alternative example from that shown in FIG. 2 is that the UTM 300 of FIG. 3 comprises a first module 300a and a second module 300b, and that the modules are connectable to one another via a second connector 34, which is a wet-mate connector. The first module 300a comprises the apparatus 37 and the housing 35 having the switchgear 50. The second module 300b comprises the termination head 33. The components are housed in separately recoverable modules, rather than a single UTM as shown in FIG. 2. This may assist in decreasing the time of repair in the event that only part of the UTM 300 needs to be removed and serviced. This allows the UTM 300 and system to have an enhanced functional availability. If the switchgear 50 is in need of replacing, service operators may disconnect the wet-mate connector 34 between the two modules, lift the first module 300a out of the water, replace the defective parts, then lower and re-join the first module 300a to the second module 300b. Furthermore, this arrangement allows the usage of less expensive lifting apparatus during repairing operations.

The installation, operation, and retrieval of the present embodiments will now be described in detail. Referring first to installing the UTM 30 of FIG. 2, the UTM 30 is initially provided on a platform above water. An operator dry-mates the UTM 30 to the termination head 33, which is connected to the umbilical cable 60, via the second connector 34. Next, the UTM 30, while in connection with the power-generating apparatus 10, is lowered underwater. Finally, the UTM 30 is directly wet-mated to the first side 24 subsea transformer module 20 via the first connector 32. In operation, the switchgear 50 is closed. The UTM 30 receives power from the offshore power-generating apparatus 10, and transfers this power to the transformer module 20, where the voltage is stepped up and distributed to various onshore components 70. If a fault is detected, the actuator moves the switchgear 50 to the open position. During retrieval, the wet-mate connection of the first connector 32 between the first side 24 of the transformer module 20 and the UTM 30 is disconnected. Next, the UTM 30 is raised above water and onto a suitable platform. Finally, the dry-mating of the second connector between the UTM 30 and the one or more power-generating apparatuses is disconnected.

While operation of the UTMs 30, 300 of FIG. 2 and FIG. 3 is the same, retrieving the UTM 300 of FIG. 3 begins with an optional step of disconnecting the first module 300a from the second module 300b via second wet-mate connector 34, then selecting one of the modules to retrieve to the surface vessel or platform. Furthermore, installing the UTM 300 of FIG. 3 begins with a step of connecting the first module 300a to the second module 300b via second connector 34.

The UTM 30, 300, having integrated switchgear 50, provides numerous technical benefits over existing power distribution systems that employ separate switchgear modules having multiple circuit breakers. Firstly, the present embodiments provide a reduction in hardware cost. It is known that wet-mate connectors are significantly more expensive than dry-mate connectors. Existing systems require their switchgear modules to be wet-mated to an umbilical termination assembly, which adds expense. The present embodiments integrating the switchgear 50 into the UTM 30, 300 means that they may be coupled via a dry-mate connector above the surface before the entire UTM 30, 300 is installed underwater. This means one less wet-mate connection is required per UTM 30, 300. Secondly, the present arrangement provides a better utilization of switchgear, dry-mate connector, and wet-mate connector power ratings. Unlike past systems, which provided a wet-mate connector between switchgear module and subsea transformer, the wet-mate connector in this arrangement is not operated close to its maximum power rating. This improves the connectors' lifetime. Thirdly, having an integrated switchgear 50 as opposed to a separate switchgear module allows for a reduction in total system size, further reducing hardware costs.

Wet-mate connectors utilized in various embodiments of the present disclosure may be any connection mechanism suitable to be mated or unmated in wet, subsea environments. Examples of such connectors that can in the present disclosure include, but are not limited to: rubber moulded connectors, which use a locking sleeve and neoprene or polyurethane over-moulding to create a water-tight seal between a female connector end and a glass-reinforced epoxy bulkhead connector; rigid shell connectors, that are moulded into a rigid body and have a water-locking mechanism involving screwing the two connector halves together before sealing the junction with an O-ring; fluid-filled connectors, which use a chamber filled with dielectric fluid, such as oil, to isolate the contacts from water until the male and female ends are-mated; and inductive couplings which magnetically adjoin components. Conversely, dry-mate connectors may be any suitable connector designed for applications wherein the plug and receptacle will be fully mated in a dry environment, then submerged into water. Examples of such connectors include glass-to-metal sealed connectors and seismic survey connectors.

Equipment ancillary to power distribution systems, such as, but not limited to, batteries, machine-side converters, grid side converters, connections between the generators and the umbilical cable, etc., have not been depicted for clarity purposes, though the inclusion and use of such equipment in electrical systems of the current disclosure would be known and appreciated by those skilled in the art.

Descriptive terms also should be given the broadest possible interpretation; e.g., the term “comprising” as used in this specification means “consisting at least in part of” such that, interpreting each statement in this specification that includes the term “comprising”, features other than that or those prefaced by the term may also be present. Related terms such as “comprise” and “comprises” are to be interpreted in the same manner.

1. A retrievable umbilical termination module, comprising:
a first connector directly connectable to a subsea transformer module, wherein the first connector is a wet-mate connector; and
a second connector connectable to one or more offshore power-generating apparatuses,
the first connector and the second connector being electrically connected to one another; and
a switchgear, the switchgear configured to selectively control the flow of power from the second connector to the first connector.

2. The UTM according to claim 1, wherein the switchgear comprises a circuit breaker.

3. The UTM according to claim 1, wherein the switchgear comprises a disconnecting switch and an actuator electrically coupled to the disconnecting switch, the actuator configured to activate or deactivate the disconnecting switch.

4. The UTM according to claim 1, wherein the second connector comprises a dry-mate connector.

5. The UTM according to claim 1, further comprising:
a first module containing the first connector and the switchgear; and
a second module connectable to the one or more offshore power-generating apparatus,
wherein the second connector is a wet-mate connector between the switchgear and the second module.

6. A subsea power system comprising:
a transformer module having a first side and a second side, the first side connectable to onshore components; and
at least one UTM comprising:
a first connector directly connectable to a subsea transformer module, wherein the first connector is a wet-mate connector; and
a second connector connectable to one or more offshore power-generating apparatuses, the first connector and the second connector being electrically connected to one another, and
a switchgear configured to selectively control the flow of power from the second connector to the first connector,
wherein the first connector is connected to the second side of the transformer module.

7. The subsea power system according to claim 6, further comprising at least one offshore power-generating apparatus connected to the second connector.

8. The subsea power system according to claim 7, wherein the at least one offshore power-generating apparatus comprises a plurality of arrays of offshore power-generating apparatus, and wherein the system comprises a respective UTM for each of the plurality of arrays.

9. A method for installing an umbilical termination module (UTM), the method comprising:
connecting a first connector to one or more offshore power-generating apparatuses prior to subsea installation;
installing the UTM subsea; and
connecting a second connector to the second side of a subsea transformer module, wherein the second connector is a wet-mate connector.

10. The method according to claim 9, wherein the UTM further comprises:
a first module containing the second connector and the switchgear, and a second module directly connectable to the one or more offshore power-generating apparatus, wherein the first connector is a wet-mate connector between the switchgear and the second module; and
wherein the method further comprises the step of connecting the switchgear and second module via the second connector subsea.

11. A method for retrieving a subsea umbilical termination module (UTM), the method comprising:
disconnecting a connector between a transformer module and the UTM, wherein the first connector is a wet-mate connector;
retrieving the UTM to a surface vessel or platform; and
disconnecting a second connector between the UTM and one or more offshore power-generating apparatuses.

12. The method according to claim 11, wherein the UTM further comprises:
a first module containing the first connector and a switchgear; and
a second module connected to the one or more offshore power-generating apparatuses,
wherein the second connector is a wet-mate connector between the switchgear and the second module.

13. The method according to claim 12, further comprising disconnecting the first module from the second module.

14. The method according to claim 12, wherein the step of retrieving the UTM comprises retrieving the first module to a surface vessel or platform.
